(19) United States
(12) Patent Application Publication
(10) Pub. No.: US 2005/0223122 A1
(43) Pub. Date: Oct. 6, 2005

(54) Integrated circuit capable of remote data storage

(76) Inventors: Mark L. Brown, Gilbert, AZ (US); Michele Clayton, Scottsdale, AZ (US); Philip J. Tait, Paradise Valley, AZ (US)

Correspondence Address: Grossman, Tucker, Perreault & Pfleger, PLLC, c/o PortfolioIP, P.O. Box 52050, Minneapolis, MN, 55402, US

(21) Appl. No.: 10/815,272

(22) Filed: Mar. 31, 2004

(51) Int. Cl. G06F 13/14

(52) U.S. Cl. 710/5

(57) ABSTRACT

A method according to one embodiment may include receiving an input/output (I/O) request to write data stored on at least one target device comprised in at least one local storage array. The method of this embodiment may also include generating one or more I/O transactions capable of writing data on at least one target device comprised in at least one remote storage array. Of course, many alternatives, variations, and modifications are possible without departing from this embodiment.

### FIELD

The present disclosure relates to an integrated circuit capable of remote data storage.

### BACKGROUND

In one conventional data storage arrangement, a computer node includes a host bus adapter (HBA). The HBA communicates with a data storage system via one or more communication links using a communication protocol associated with the one or more links. In the conventional data storage arrangement, the data storage system is a local data storage system, and may be used for data backup operations. In such an arrangement, there is no mechanism to store data remotely, and thus, if local data is compromised, there is no mechanism to restore data. Thus, the conventional data storage arrangement is incapable of achieving remote data backup and/or remote data recovery.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a diagram illustrating a system embodiment;

FIG. 2 is a diagram illustrating another system embodiment;

FIG. 3 is a diagram illustrating another system embodiment;

FIG. 4 is a flowchart illustrating exemplary operations according to one embodiment; and

FIG. 5 is a flowchart illustrating exemplary operations according to one embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

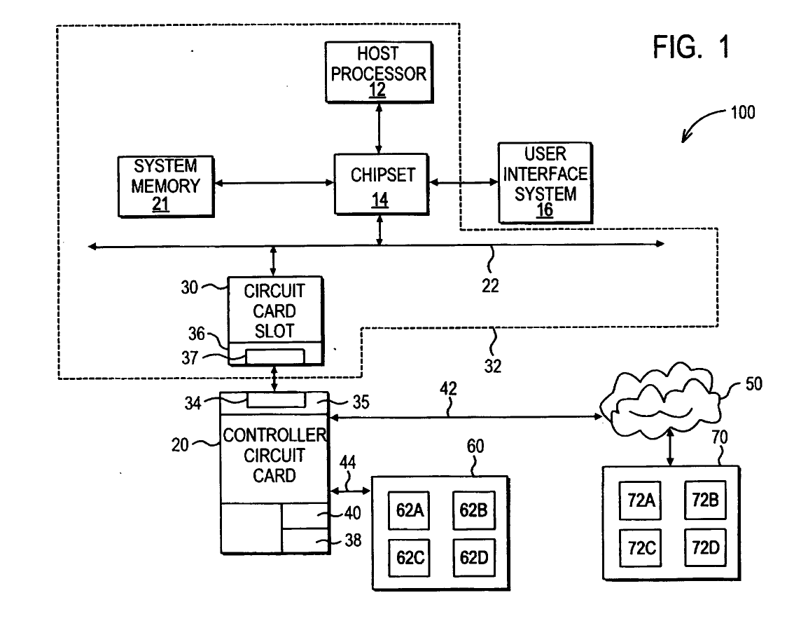

FIG. 1 illustrates a system embodiment 100 of the claimed subject matter. The system 100 may generally include a host processor 12, a bus 22, a user interface system 16, a chipset 14, system memory 21, a circuit card slot 30, and a circuit card 20 configured to communicate with mass storage array 60 and/or 70 (hereinafter “storage array 60 and/or 70”). The host processor 12 may include any variety of processors known in the art such as an Intel® Pentium® IV processor commercially available from the Assignee of the subject application. The bus 22 may include various bus types to transfer data and commands. For instance, the bus 22 may comply with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). The bus 22 may also comply with the PCI-X Specification Rev. 1.0a, Jul. 24, 2000, available from the aforesaid PCI Special Interest Group, Portland, Oreg., U.S.A.

The user interface system 16 may include a variety of devices for human users to input commands and/or data and to monitor the system such as a keyboard, pointing device, and video display. The chipset 14 may include host bridge/hub system (not shown) that couples the processor 12, system memory 21, and user interface system 16 to each other and to the bus 22, and may comprise a host system. Chipset 14 may include integrated circuit chips, such as those selected from integrated circuit chipsets commercially available from the assignee of the subject application (e.g., graphics memory and I/O controller hub chipsets), although other integrated circuit chips may also, or alternatively be used. The processor 12, system memory 21, chipset 14 and circuit card slot 30 may be integrated onto one circuit board, e.g. motherboard 32.

The circuit card 20 may be constructed to permit it to be inserted into slot 30. When the circuit card 20 is properly inserted into slot 30, connectors 34 and 37 become electrically and mechanically coupled to each other. When connectors 34 and 37 are so coupled to each other, the card 20 becomes electrically coupled to bus 22 and may exchange data and/or commands with system memory 21, host processor 12, and/or user interface system 16 via bus 22 and chipset 14. Alternatively, without departing from this embodiment, the operative circuitry of the circuit card 20 may be included in other structures, systems, and/or devices. These other structures, systems, and/or devices may be, for example, in the motherboard 32, coupled to the bus 22.

Circuit card 20 may communicate with storage array 60 and/or 70 using a plurality of communication protocols. The circuit card 20 may comprise protocol initiator engine circuitry 40 and I/O controller circuitry 38. As used in any embodiment herein, “circuitry” may comprise, for example, singly or in any combination, hardwired circuitry, programmable circuitry, state machine circuitry, and/or firmware that stores instructions executed by programmable circuitry. Initiator engine circuitry 40 (herein after “initiator 40”) and/or I/O controller circuitry 38 (hereinafter “I/O controller 38”) and/or other circuitry comprised in circuit card 20 may individually or collectively comprise one or more integrated circuits. As used in any embodiment herein, an “integrated circuit” means a semiconductor device and/or microelectronic device, such as, for example, a semiconductor integrated circuit chip. Circuit card 20 may also comprise memory (not shown) which may comprise one or more of the following types of memory: semiconductor firmware memory, programmable memory, non-volatile memory, read only memory, electrically programmable memory, random access memory, flash memory, magnetic disk memory, and/or optical disk memory. Either additionally or alternatively, memory may comprise other and/or later-developed types of computer-readable memory. Machine-readable firmware program instructions may be stored in memory. As described below, these instructions may be accessed and executed by one or more integrated circuits comprised in circuit card 20 and/or initiator 40 and/or I/O controller 38 and/or other circuitry comprised in circuit card 20, and these instructions may result in circuit card 20 performing the operations described herein as being performed by initiator 40 and/or I/O controller 38 and/or other circuitry comprised in circuit card 20. Initiator 40 may be capable of initiating communication between the host system and the storage array 60 and/or 70. I/O controller 38 may be capable of generating one or more I/O transactions to exchange commands and data between the host system and the storage array 60 and/or 70.

If a Fibre Channel (FC) protocol is used by initiator 40 to exchange data and/or commands with storage array 60 and/or 70, it may comply or be compatible with the interface/protocol described in ANSI Standard Fibre Channel Physical and Signaling Interface-3 X3.303:1998 Specification. Alternatively or additionally, if a serial ATA (S-ATA) protocol is used by initiator 40 to exchange data and/or commands with storage array 60 and/or 70, it may comply or be compatible with the protocol described in “Serial ATA: High Speed Serialized AT Attachment,” Revision 1.0, published on Aug. 29, 2001 by the Serial ATA Working Group. Further alternatively or additionally, if a serial attached small computer system interface (SAS) protocol is used by initiator 40 to exchange data and/or commands with storage array 60 and/or 70, it may comply or be compatible with the protocol described in “Information Technology-Serial Attached SCSI-1.1,” Working Draft American National Standard of International Committee For Information Technology Standards (INCITS) T10 Technical Committee, Project T10/1562-D, Revision 1, published Sep. 18, 2003, by American National Standards Institute (hereinafter termed the “SAS Standard”) and/or later-published versions of the SAS Standard. The SAS protocol may comprise Serial Advanced Attachment (ATA) Tunneled Protocol (STP) and Serial Small Computer System Interface (SCSI) Protocol (SSP). Of course, other alternative communication protocols and/or after-developed communication protocols may be used by circuit card 20 without departing from this embodiment, and such alternative and/or after-developed communications protocols shall be deemed equivalent communications protocols.

Card 20 may be coupled to mass storage 60 and/or 70 via one or more network communication links 44 and/or 42, respectively. As is discussed below, card 20 may exchange data and/or commands with mass storage 60 and/or 70, via links 44 and/or 42, using, e.g., S-ATA, SAS and/or FC communication protocols. Of course, alternatively, card 20 may exchange data and/or commands with mass storage 60 and/or 70 using other and/or additional communication protocols, without departing from this embodiment.

Controller card 20 may be coupled to and control the operation of mass storage 60 and/or 70. In this embodiment, storage array 60 may comprise, e.g., one or more redundant arrays of independent disks (RAID) 62A, 62B, 62C and/or 62D. The RAID level that may be implemented by RAID storage array 60 may comprise Level 0, 1, 10, 1E or greater than 1. Likewise, storage array 70 may comprise a RAID storage array. The RAID level that may be implemented by RAID storage array 70 may comprise Level 0, 1, 10, 1E or greater than 1. Disks comprised in storage array 60 and/or 70 may be referred to herein as “target disks” or “target devices”, and such terms may be used interchangeably herein.

Storage array 60 and/or 70 may be comprised in one or more respective enclosures that may be separate from the enclosure in which the motherboard 32 and the components comprised in the motherboard 32 are enclosed. In at least one embodiment herein, storage array 70 comprises a geographically remote mass storage array comprising one or more disks 72A, . . . ,and/or 72D. Geographically remote mass storage 70 may communicate with card 20 via a storage network 50. “Geographically remote” or “remote”, as used in any embodiment herein, may be defined as a predefined distance from a host system (such as motherboard 32). Storage network 50 may comprise, for example, a storage area network (SAN). SAN 50 may comply or be compatible with FC communication protocols and/or internet Small Computer System Interface (iSCSI) communication protocols. For example, one or more target devices comprised in storage array 70 may comply or be compatible with FC protocols, storage network 50 may comprise a FC network that may comply or be compatible with FC communication protocols. Alternatively or additionally, one or more target devices comprised in storage array 70 may comply or be compatible with SAS and/or S-ATA communication protocols, storage network 50 may comprise an iSCSI network that may permit communication between circuit card 20 and such SAS and/or S-ATA compatible disks using, for example, SAS and/or S-ATA commands over transmission communication protocol/internet protocol (TCP/IP) communication protocols. If network 50 is an iSCSI network it may comply or be compatible with the protocol described in “Small Computer Systems Interface protocol over the Internet (iSCSI) Requirements and Design Considerations”, published July 2002 by The Internet Society. To that end, initiator circuit card 20 may comprise circuitry to generate TCP/IP communication protocols capable of communicating with storage array 70 over network 50. Such a network 50 may permit, for example, storage array 70 to be several kilometers away from system motherboard 32 and/or circuit card 20. Storage array 60, in at least one embodiment, may comprise a local storage array. “Local”, as used in any embodiment, may be defined as within a predefined distance from a host system 32.

I/O controller 38 may be capable of generating one or more I/O commands. Such I/O commands may be transmitted to one or more target devices comprised storage array 60 and/or 70, via, for example, communication links 42 and/or 44. “I/O”, as used in any embodiment herein may comprise a transaction. A transaction may comprise, for example, a read and/or write request between the host system and mass storage array 60 and/or 70.

Although not shown in the figures, circuit card 20 may comprise one or more physical interfaces (PHY) capable of electrically coupling circuit card 20 with storage array 60 and/or 70. A “PHY” may be defined as an object and/or circuitry used to interface to one or more devices, and such object and/or circuitry may be defined by one or more of the communication protocols set forth herein. The PHY may comprise a physical PHY containing transceiver circuitry to interface to the applicable communication link. The PHY may alternately and/or additionally comprise a virtual PHY to interface to another virtual PHY or to a physical PHY. Each PHY may have a unique identifier. A port may contain one or more PHYs. For example, a narrow port may contain only one PHY, while a wide port may contain more than one PHY. One or more PHYs may be capable of communicating one or more I/O commands between circuit card 20 and storage array 60 and/or 70.

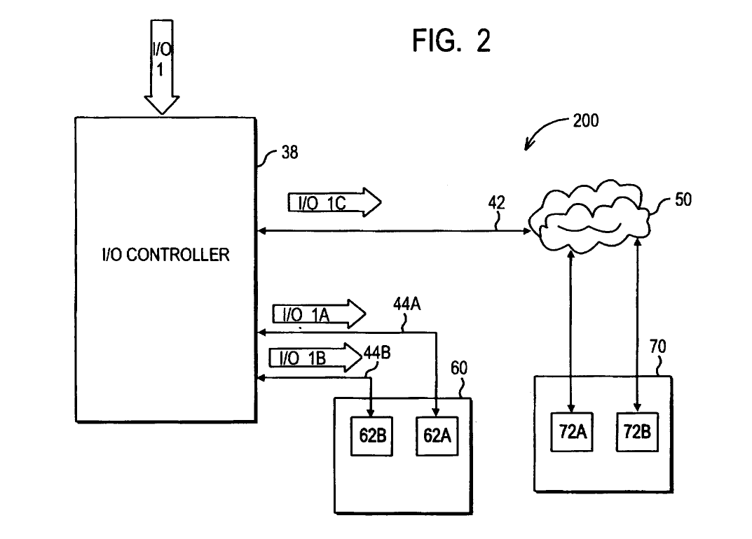

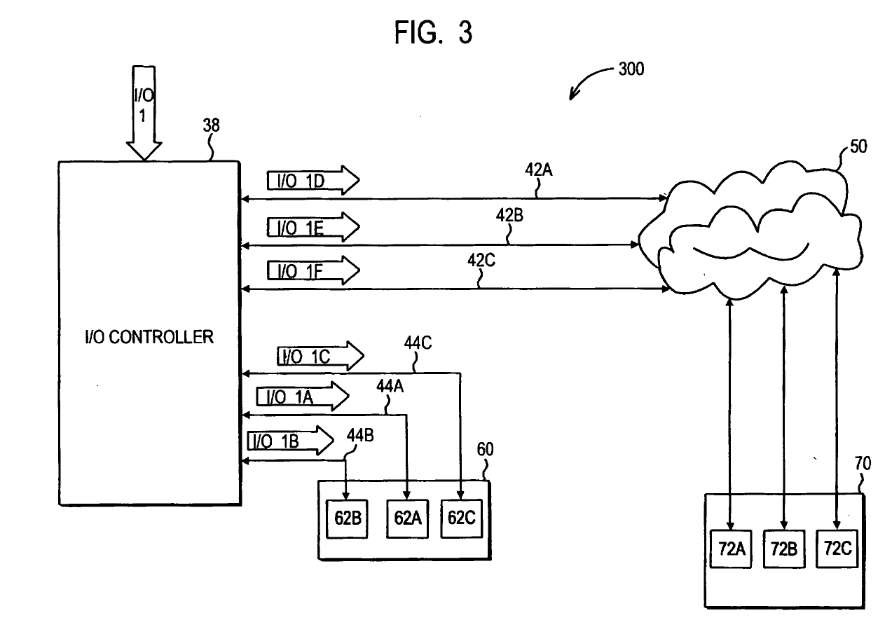

I/O controller 38 may be capable of receiving an I/O to read and/or write data to or from one or more target devices comprised in storage array 60. Such an I/O may be generated by, for example a host system. In this embodiment, I/O controller 38 may also be capable of generating one or more additional I/O transactions to execute the same or similar data write and/or read request to one or more disks comprised in storage array 70. Thus, for a single data write I/O received by I/O controller 38, I/O controller 38 may be capable of generating one or more I/O commands to one or more disks comprised in local storage array 60 and local storage array 70. Exemplary system embodiments are described in detail below with reference to FIGS. 2 and 3.

RAID Level 1

FIG. 2 illustrates another system embodiment 200 of the claimed subject matter. In FIG. 2, certain portions of the system 100 depicted in FIG. 1 have been omitted for clarity (for example circuit board 32 and circuit card 20), but it is to be understood that like parts of FIG. 2 can be implemented in a manner consistent with an embodiment depicted in FIG. 1, or alternatively in other system implementations, without departing from this embodiment.

In this embodiment, mass storage 60 and mass storage 70 may comprise RAID Level 1 storage array. RAID Level 1 may be defined as a data mirroring mechanism in which data is duplicated on one or more disk devices comprised in storage array 60. Thus, for example, RAID Level 1 may mirror data on disks 62A and 62B. Also, according to this embodiment, data may also be mirrored on disks 72A and 72B comprised in mass storage 70. In other words, under RAID Level 1, identical data may be written on disks 62A, 62B in the local storage array 60, and 72A and 72B in the remote storage array 70. In this embodiment mass storage 70 may be a geographically remote storage array, which may exchange commands and data with initiator engine 40 via network 50 and communications link 42. Also in this embodiment, mass storage 60 may be a local RAID. In this embodiment, initiator engine 40 may be capable of configuring RAID 70 as a component of RAID 60, so that data is written to both locations in a manner described below. Configuration of RAID 70 may be stored as configuration data in memory comprised in circuit card 20 and accessed by circuit card 20 upon receiving an I/O request.

In operation, I/O controller 38 may receive a data write request, for example, from host system 32. The data write request may comprise an I/O transaction request, labeled as “I/O 1” in FIG. 2. In this embodiment, the I/O controller 38 may be capable, at least in part, of generating a plurality of I/O transactions in response to an I/O transaction request received by the circuit card 20. The plurality of I/O transactions generated by the I/O controller 38 may comprise identical or substantially identical data write instructions as the data write instructions comprised in the received I/O transaction (I/O 1). For example, in this embodiment, I/O controller 38 may be capable of generating, I/O transactions labeled “I/O 1A”, “I/O 1B” and “I/O 1C” in response to the I/O transaction (I/O 1) received by I/O controller 38.

I/O 1A and I/O 1B may be transmitted to disks 62A and 62B (comprised in storage array 60), respectively, via communication links 44A and 44B. I/O controller 38 may cause identical or substantially identical data to be written to disks 62A and 62B, as may be provided by RAID Level 1. Additionally, in this embodiment, I/O 1C may be transmitted to disks 72A and 72B (comprised in storage array 70), via communications link 42 and network 50. Thus, initiator engine may cause a RAID Level 1 data write to both storage array 60 and storage array 70 from a single I/O transaction. Once the data write is completed on one or more disks in storage array 60 and 70, the storage arrays may be capable of transmitting a signal to I/O controller 38 indicative of the fact that the data write is complete at each respective storage array. I/O controller 38 may be capable of receiving such a signal, and may further be capable of reporting a successful transaction to a host system.

In this embodiment, I/O 1C may be transmitted across a remote path, via network 50. There may be a greater likelihood of a network failure or remote storage array 70 being offline or otherwise inaccessible. These situations may cause initiator engine 40 to continue data write attempts to remote storage array 70, and may cause frequent mirroring attempts to the remote array 70. Thus, the circuit card 20 of the present embodiment may be capable of determining the operational status of the network 50 and/or remote array 70. If the network 50 and/or remote array 70 are inoperable during an I/O transmission, the circuit card 20 may be capable of creating an image (for example, a bitmap image) representing data that is to be written to remote array 70. Circuit card 20 may also be capable of controlling one or more disks comprised in the local array 60 to store the bitmap image representing data that is to be written to remote array 70 on one or more disks comprised in array 60. Circuit card 20 may also include a counter (not shown), for example, by designating a portion of memory comprised in circuit card 20 as counter memory. The counter may include a plurality of bits which may correspond to one or more blocks of data (data blocks) comprised in the data write transaction represented by I/O 1.

In operation, circuit card 20 may determine that network 50 and/or remote array 70 are inoperable, either during the transmission of data, or at the start of such data transmission. If network 50 and/or remote array 70 are inoperable during the transmission of data (I/O 1C), circuit card 20 may be capable of determining which data blocks did not get written to the remote array 70. Circuit card 20 may increment the bits corresponding to the data blocks did not get written to the remote array 70 in counter memory. In subsequent I/O attempts to remote array 70, circuit card 20 may read the counter memory to determine which data blocks to attempt to resend to remote array 70. As described above, these unwritten data blocks may be stored on one or more disks in the local array 60 (or elsewhere in system 100). Once data is successfully written for a given I/O transaction, the counter may be reset.

RAID Level 0

FIG. 3 illustrates another system embodiment 300 of the claimed subject matter. In FIG. 3, certain portions of the system 100 depicted in FIG. 1 have been omitted for clarity (for example circuit board 32 and circuit card 20), but it is to be understood that like parts of FIG. 3 can be implemented in a manner consistent with an embodiment depicted in FIG. 1, or alternatively in other system implementations, without departing from this embodiment.

In this embodiment, mass storage 60 and mass storage 70 may comprise RAID Level 0 storage array. RAID Level 0 may be defined as data striping in which data stripped across two or more disk devices comprised in storage array 60. Thus, for example, RAID Level 0 may stripe data on disks 62A, 62B and 62C. Striping may comprise, for example, storing sequential stripes of data on separate disks in the array. The stripe may comprise a user-definable or preset stripe unit size, which may represent the granularity of the amount of data in a stripe. As an example of striping, and assuming a stripe size of 1 data block, Block 1 may be stored on disk 62A, block 2 on 62B, block 3 on 62C, block 4 on 62A, and so on. Also, according to this embodiment, data may also be striped on disks 72A, 72B and 72C comprised in mass storage 70. Thus, for example, under RAID Level 0, identical data may be written on disks 62A and 72A, and likewise for disks 62B, 72B and 62C, 72C. In this embodiment mass storage 70 may be a geographically remote storage array, which may exchange commands and data with circuit card 20 via network 50 and communications link 42. Also in this embodiment, mass storage 60 may be a local RAID. In this embodiment, circuit card 20 may be capable of configuring RAID 70 as a component of RAID 60, so that data is written to both locations in a manner described below. Configuration of RAID 70 may be stored as configuration data in memory comprised in circuit card 20 and accessed by circuit card 20 upon receiving an I/O request.

In operation, I/O controller 38 may receive a data write request, for example, from host system 32. The data write request may comprise an I/O transaction request, labeled as “I/O 1” in FIG. 3. In this embodiment, the I/O controller 38 may be capable, at least in part, of generating a plurality of I/O transactions in response to an I/O transaction request received by the I/O controller 38. The plurality of I/O transactions generated by the I/O controller 38 may comprise data write transactions in accordance with RAID Level 0. For example, in this embodiment, I/O controller 38 may be capable of generating, I/O transactions labeled “I/O 1A”, “I/O 1B” and “I/O 1C” in response to the I/O transaction (I/O 1) received by I/O controller 38. I/O 1A, I/O 1B and I/O 1C may represent data striping I/O transactions for disks 62A, 62B and 62C, respectively.

I/O 1A, I/O 1B and I/O 1C may be transmitted to disks 62A, 62B and 62C, (comprised in storage array 60), respectively, via communication links 44A, 44B and 44C, respectively. I/O controller 38 may cause data to be stripped across disks 62A, 62B and 62C, as may be provided by RAID Level 0. Additionally, in this embodiment, I/O controller 38 may also generate I/O 1D, I/O 1E and I/O 1F, which may be transmitted to disks 72A, 72B and 72C (comprised in storage array 70), respectively, via communications links 42A, 42B and 42C, respectively and network 50. Thus, circuit card 20 may cause a RAID Level 0 data write to both storage array 60 and storage array 70 from a single I/O transaction. Once the data write is completed on one or more disks in storage array 60 and 70, the storage arrays may be capable of transmitting a signal to initiator engine 40 indicative of the fact that the data write is complete at each respective storage array. I/O controller 38 may be capable of receiving such a signal, and may further be capable of reporting a successful transaction to a host system.

In this embodiment, I/O 1D, I/O 1E and/or I/O 1F may be transmitted across a remote path, via network 50. There may be a greater likelihood of a network failure or remote storage array 70 being offline or otherwise inaccessible. These situations may cause I/O controller 38 to continue data write attempts to remote storage array 70, and may cause frequent mirroring attempts to the remote array 70. Thus, the I/O controller 38 of the present embodiment may be capable of determining the operational status of the network 50 and/or remote array 70. If the network 50 and/or remote array 70 are inoperable during an I/O transmission, the circuit card 20 may be capable of creating an image (for example, a bitmap image) representing data that is to be written to remote array 70. Circuit card 20 may also be capable of controlling one or more disks comprised in the local array 60 to store the bitmap image representing data that is to be written to remote array 70 on one or more disks comprised in array 60. Circuit card 20 may also include a counter (not shown), for example, by designating a portion of memory comprised in circuit card 20 as counter memory. The counter may include a plurality of bits which may correspond to one or more blocks of data (data blocks) comprised in the data write transaction represented by I/O 1.

In operation, circuit card 20 may determine that network 50 and/or remote array 70 are inoperable, either during the transmission of data, or at the start of such data transmission. If network 50 and/or remote array 70 are inoperable during the transmission of data, circuit card 20 may be capable of determining which data blocks did not get written to the remote array 70. Circuit card 20 may increment the bits corresponding to the data blocks did not get written to the remote array 70 in counter memory. In subsequent data write attempts to remote array 70, circuit card 20 may read the counter memory to determine which data blocks to attempt to resend unwritten data to remote array 70. As described above, these unwritten data blocks may be stored on one or more disks in the local array 60 (or elsewhere in system 100). Once data is successfully written for a given I/O transaction, the counter may be reset.

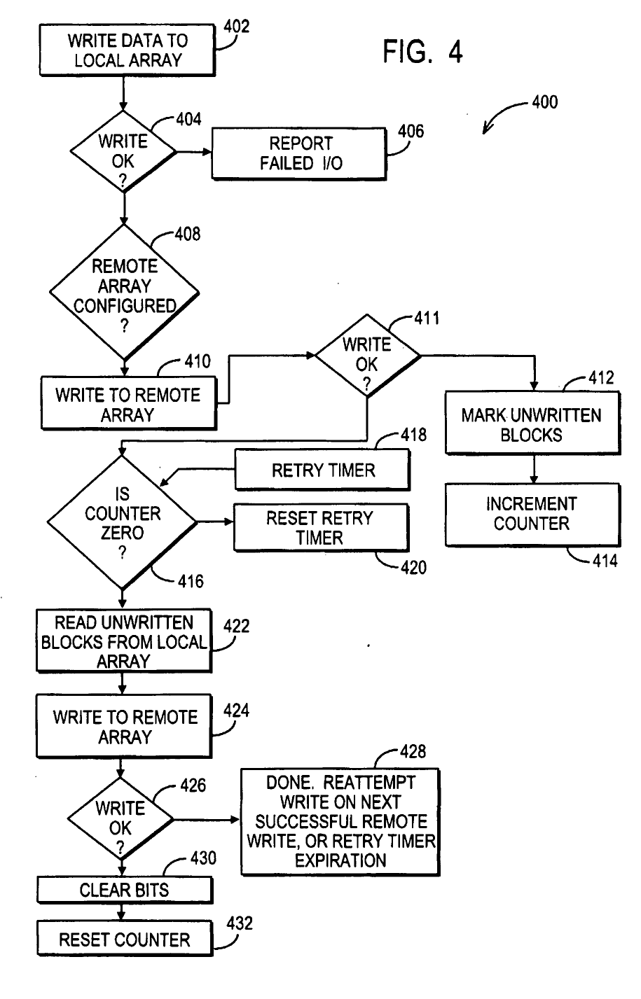

FIG. 4 depicts a flowchart 400 of exemplary operations which may be performed according to an embodiment. The flowchart 400 of FIG. 4 may comprise data write operations which may be performed. Operations may include a data write to a local storage array 402. Operations may also include determining if the data write to the local storage array is successful 404. If not successful, operations may also include a report of a failed I/O 406. Operations may also include determining if a remote storage array is configured to receive data 408. If a remote array is configured to receive data, operations may also include writing data to the remote array 410. Operations may also include determining if the data write to the remote storage array is successful 411. If data write operations to the remote array are not successful in whole or in part, operations may also include marking unwritten data blocks 412 which may comprise writing unwritten data blocks to the local storage array, and operations may also include incrementing a counter 414 reflective of unwritten data. If data write operations to the remote array are successful, operations may also include determining a counter reflective of unwritten data is zero 416. A zero counter may mean that no unwritten data remains, and operations may also include resetting a retry timer 420. A retry timer may be used to retry write operations to the remote array, and when the retry timer is reset, additional data write attempts to the remote array may be cancelled. If the counter is not zero, which may be indicative of unwritten data to the remote array, operations may also include reading unwritten data blocks from the local array 422, and writing to the remote array 424. Operations may also include determining if the data write to the remote storage array is successful 426. If not successful, operations may conclude and a data write reattempt may be attempted on the next remote write operations and/or upon expiration of the retry timer 428. If data write operations are successful, operations may include clear bits in the counter 430 and resetting the counter 432.

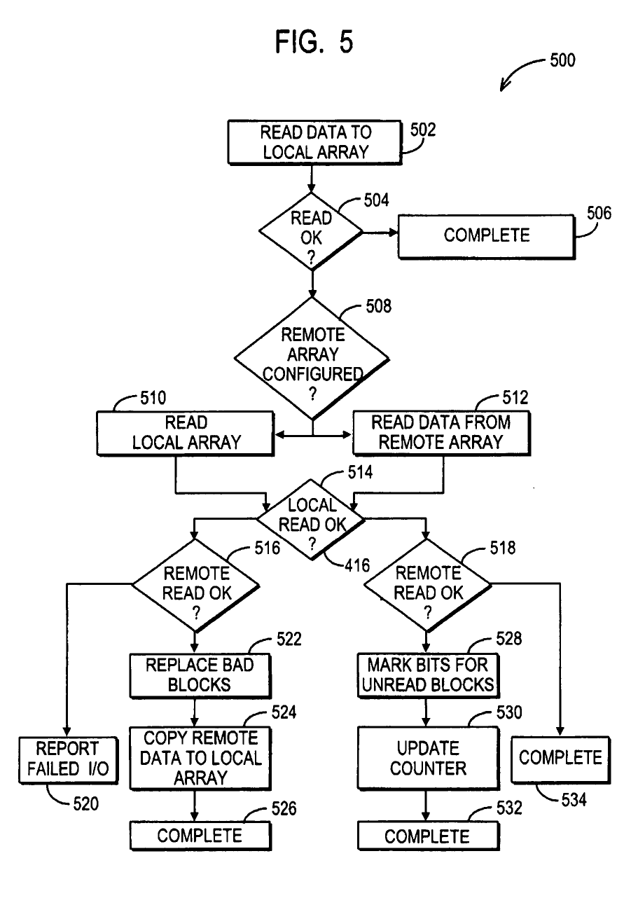

FIG. 5 depicts a flowchart 500 of exemplary operations which may be performed according to an embodiment. The flowchart 500 of FIG. 5 may comprise data read operations which may be performed. Operations may include a data read from a local storage array 502. Operations may also include determining if the data read from the local storage array is successful 504. If successful, operations may be completed 506. If not successful, operations may also include determining if a remote array is configured to permit a data read 508. If a remote array is configured for a data read, operations may also include retry a data read from the local array 510 and/or reading data from the remote array 512. Operations may also include determining if the local read attempt is successful 514. If the local read attempt fails, operations may include determining if the remote read attempt is successful 516. If the remote read attempt is not successful, operations may include reporting a failed I/O 520. If the remote read attempt is successful, operations may include replacing bad data blocks of the local array 522 which may comprise copying data from the remote array to the local array 524. Operations may conclude 526. If the local read attempt fails 514, operations may include determining if the remote read attempt is successful 518. If the remote read attempt is not successful, operations may include marking bits in a counter for unread data blocks 528 which may also include updating the counter 530 to reflect unread data and concluding operations 532. If the remote read attempt is successful 518, operations may conclude 534.

Thus, in summary, at least one embodiment described herein may comprise an integrated circuit capable of receiving an input/output (I/O) request to write data stored on at least one target device comprised in at least one local storage array. The integrated circuit may be further capable of generating one or more I/O transactions capable of writing data on at least one target device comprised in at least one remote storage array. Such an embodiment, as provided herein, may provide remote data storage, for example, in response to a local data storage request. Such an embodiment may operate to enhance data integrity by providing a local and/or remote copy of data.

Also, embodiments herein describe the operations of one or more integrated circuits comprised in circuit card 20, however, it should be understood that other integrated circuits may be capable of such operations, for example, integrated circuits comprised in host system 32 and or other integrated circuits not shown herein. Further, although not shown in the system embodiments of FIGS. 1-3, such embodiment may also comprise expanders and/or bridges and/or repeaters to achieve the stated operations and/or other operations.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

1. An apparatus, comprising:
an integrated circuit capable of receiving an input/output (I/O) request to write data stored on at least one target device comprised in at least one local storage array, said integrated circuit further capable of generating one or more I/O transactions capable of writing data on at least one target device comprised in at least one remote storage array.

2. The apparatus of claim 1, wherein:
said integrated circuit is further capable of generating one or more I/O transactions capable of writing data stored on said at least one target device comprised in said at least one local storage array.

3. The apparatus of claim 1, wherein:
said local storage array and said remote storage array each comprise a redundant array of inexpensive disks (RAID) each comprising RAID Level 1 storage arrays.

4. The apparatus of claim 3, wherein:
said one or more I/O transactions capable of writing data on at least one target device comprised in at least one remote storage array comprises a transaction to mirror data on said RAID Level 1 storage array in response to said I/O request to write data stored on at least one target device comprised in at least one local storage array.

5. The apparatus of claim 1, wherein:
said local storage array and said remote storage array each comprise a redundant array of inexpensive disks (RAID) each comprising at least one of RAID Level 0, RAID Level 10 and RAID Level 1E storage arrays.

6. The apparatus of claim 5, wherein:
said one or more I/O transactions capable of writing data on at least one target device comprised in at least one remote storage array comprises a transaction to stripe data on at least one of said RAID Level 0, RAID Level 10 and RAID Level 1E storage arrays in response to said I/O request to write data stored on at least one target device comprised in at least one local storage array.

7. The apparatus of claim 1, wherein:
said integrated circuit further capable of receiving an input/output (I/O) request to read data on at least one target device comprised in at least one local storage array, said integrated circuit further capable of generating one or more I/O transactions capable of reading data on at least one target device comprised in at least one remote storage array.

8. A method, comprising:
receiving an input/output (I/O) request to write data stored on at least one target device comprised in at least one local storage array; and
generating one or more I/O transactions capable of writing data on at least one target device comprised in at least one remote storage array.

9. The method of claim 8, further comprising:
generating at least one of said I/O transactions to mirror data on said local storage array and said remote storage array.

10. The method of claim 8, further comprising:
generating at least one of said I/O transactions to stripe data on said local storage array and said remote storage array.

11. The method of claim 8, further comprising:
receiving an I/O request to read data on said at least one target device comprised in said at least one local storage array; and
generating one or more I/O transactions capable of reading data on said at least one target device comprised in said at least one remote storage array.

12. The method of claim 11, further comprising:
determining the status of said remote storage array, and, if said remote storage array is incapable of transmitting data in response to said one or more I/O transactions, regenerating said one or more I/O transactions to read data to said remote storage array at one or more preselected times.

13. The method of claim 12, further comprising:
storing information based on data unread from said remote storage array on said local storage array, and, retrieving said information based on data unread from said local storage array.

14. The method of claim 8, further comprising:
determining the status of said remote storage array, and, if said remote storage array is incapable of receiving data, regenerating said one or more I/O transactions to write data on said remote storage array at one or more preselected times.

15. The method of claim 14, further comprising:
storing information on said local storage array based on unwritten data related to said I/O transactions to write data to said remote storage array, and, retrieving said information based on unwritten data from said local storage array and writing said unwritten data to said remote storage array.

16. The method of claim 11, further comprising: copying data from said at least one target device comprised in said at least one remote storage array to said at least one target device comprised in said local storage array.

17. A system, comprising:
a circuit card comprising an integrated circuit capable of communicating in accordance with a plurality of different communication protocols, the circuit card being capable of being coupled to a bus, and said integrated circuit further capable of receiving an input/output (I/O) request to write data stored on at least one target device comprised in at least one local storage array, said integrated circuit further capable of generating one or more I/O transactions capable of writing data on at least one target device comprised in at least one remote storage array.

18. The system of claim 17, wherein:
said integrated circuit is further capable of generating one or more I/O transactions capable of writing data stored on said at least one target device comprised in said at least one local storage array.

19. The system of claim 17, wherein:
said local storage array and said remote storage array each comprise a redundant array of inexpensive disks (RAID) each comprising RAID Level 1 storage arrays.

20. The system of claim 19, wherein:
said one or more I/O transactions capable of writing data on at least one target device comprised in at least one remote storage array comprises a transaction to mirror data on said RAID Level 1 storage array in response to said I/O request to write data stored on at least one target device comprised in at least one local storage array.

21. The system of claim 17, wherein:
said local storage array and said remote storage array each comprise a redundant array of inexpensive disks (RAID) each comprising at least one of RAID Level 0, RAID Level 10 and RAID Level 1E storage arrays.

22. The system of claim 21, wherein:
said one or more I/O transactions capable of writing data on at least one target device comprised in at least one remote storage array comprises a transaction to stripe data on at least one of said RAID Level 0, RAID Level 10 and RAID Level 1E storage arrays in response to said I/O request to write data stored on at least one target device comprised in at least one local storage array.

23. The system of claim 17, wherein:
said integrated circuit further capable of receiving an input/output (I/O) request to read data on at least one target device comprised in at least one local storage array, said integrated circuit further capable of generating one or more I/O transactions capable of reading data on at least one target device comprised in at least one remote storage array.

24. An article comprising:
a storage medium having stored thereon instructions that when executed by a machine result in the following operations:
receiving an input/output (I/O) request to write data stored on at least one target device comprised in at least one local storage array; and
generating one or more I/O transactions capable of writing data on at least one target device comprised in at least one remote storage array.

25. The article of claim 24, wherein said instructions that when executed by said machine result in the following additional operations:
generating at least one of said I/O transactions to mirror data on said local storage array and said remote storage array.

26. The article of claim 24, wherein said instructions that when executed by said machine result in the following additional operations:
generating at least one of said I/O transactions to stripe data on said local storage array and said remote storage array.

27. The article of claim 24, wherein said instructions that when executed by said machine result in the following additional operations:
receiving an I/O request to read data on said at least one target device comprised in said at least one local storage array; and
generating one or more I/O transactions capable of reading data on said at least one target device comprised in said at least one remote storage array.

28. The article of claim 27, wherein said instructions that when executed by said machine result in the following additional operations:
determining the status of said remote storage array, and, if said remote storage array is incapable of transmitting data in response to said one or more I/O transactions, regenerating said one or more I/O transactions to read data to said remote storage array at one or more preselected times.

29. The article of claim 28, wherein said instructions that when executed by said machine result in the following additional operations:
storing information based on data unread from said remote storage array on said local storage array, and, retrieving said information based on data unread from said local storage array.

30. The article of claim 24, wherein said instructions that when executed by said machine result in the following additional operations:
determining the status of said remote storage array, and, if said remote storage array is incapable of receiving data, regenerating said one or more I/O transactions to write data on said remote storage array at one or more preselected times.

31. The article of claim 30, wherein said instructions that when executed by said machine result in the following additional operations:
storing information on said local storage array based on unwritten data related to said I/O transactions to write data to said remote storage array, and, retrieving said information based on unwritten data from said local storage array and writing said unwritten data to said remote storage array.
